(19) United States
(12) Patent Application Publication
(10) Pub. No.: US 2020/0109791 A1
(43) Pub. Date: Apr. 9, 2020

(54) Pressure-Relief Device With a Variable Mass Flow Rate

(71) Applicant: Bayerische Motoren Werke Aktiengesellschaft, Muenchen (DE)

(72) Inventor: Simon HETTENKOFER, Muenchen (DE)

(21) Appl. No.: 16/704,682

(22) Filed: Dec. 5, 2019

Related U.S. Application Data
(63) Continuation of application No. PCT/EP2018/063575, filed on May 23, 2018.

(30) Foreign Application Priority Data
Jun. 7, 2017 (DE) 10 2017 209 580.6

(51) Int. Cl. F16K 17/30; F17C 13/12

(52) U.S. Cl. CPC F16K 17/30; F17C 13/12; F17C 2270/0168; F17C 2223/0123; F17C 2205/0332; F17C 2221/012; F17C 2223/036

(57) ABSTRACT

A pressure-relief device is provided for a pressure vessel for storing a fuel which is gaseous at ambient pressure. The pressure-relief device is designed, upon complying with a triggering condition, to open a duct between a pressure vessel connection element of the pressure-relief device and an outlet opening of the pressure-relief device, with the result that fuel can flow out of a pressure vessel connected to the pressure vessel connection element into the surroundings of the pressure vessel via the duct in order to reduce an internal pressure in the interior of the pressure vessel. The pressure-relief device is designed to reduce the cross section of the duct with reducing internal pressure in the pressure vessel connected to the pressure vessel connection element.

### CROSS REFERENCE TO RELATED APPLICATIONS

This application is a continuation of PCT International Application No. PCT/EP2018/063575, filed May 23, 2018, which claims priority under 35 U.S.C. § 119 from German Patent Application No. 10 2017 209 580.6, filed Jun. 7, 2017, the entire disclosures of which are herein expressly incorporated by reference.

### BACKGROUND AND SUMMARY OF THE INVENTION

The invention relates to a pressure-relief device for a pressure vessel, wherein the pressure-relief device is adapted to vary the mass flow of a fluid exiting from the pressure vessel.

A motorized road vehicle can have a fuel cell, which, on the basis of a fuel such as hydrogen, generates electrical energy for operating, in particular for powering, the vehicle. The fuel can be stored in one or a plurality of pressure vessels or pressure tanks in the vehicle, wherein a pressure vessel has one or a plurality of pressure vessel walls, which enclose a space to accommodate the fuel. The fuel can be led via a valve from the pressure vessel to the fuel cell of the vehicle. A pressure vessel can be disposed on the underside or in the floor pan of a vehicle.

A pressure vessel for storing fuel typically has at least one pressure-relief device, via which the fuel can be released from the pressure vessel in the event of a risk of damage (in particular bursting) to the pressure vessel being detected. The risk of damage to the pressure vessel can be reduced in this way. On the other hand, the outflowing fuel can possibly constitute a risk in the immediate vicinity of the pressure vessel.

The present document is concerned with the technical task of making available a pressure-relief device for a pressure vessel, by means of which the safety of the pressure vessel and of the vicinity of the pressure vessel can be increased.

The object is accomplished by the independent claims. Advantageous embodiments are described inter alia in the dependent claims. Attention is drawn to the fact that additional characterizing features of a patent claim that is dependent on an independent patient claim, without the characterizing features of the independent patent claim or only in combination with a part of the characterizing features of the independent claim, can constitute a separate invention that is independent of the combination of all the characterizing features of the independent patent claim, which can be made the subject-matter of an independent claim, a divisional application or a subsequent application. The same is true of the technical teachings that are described in the description, which can constitute an invention that is independent of the characterizing features of the independent claims.

According to one feature, a pressure-relief device (e.g. a Temperature Pressure Relief Device, TPRD) for a pressure vessel is described. The pressure vessel can be designed for the storage of a fuel (in particular H2) that is in gaseous form at ambient pressure. The pressure-relief device can contain a valve. The pressure-relief device can be connected to an opening of a pressure vessel via a pressure vessel connection element, so that the opening is closed in a closed state of the pressure-relief device. For example, the pressure vessel connection element can be screwed onto the opening of the pressure vessel.

The pressure-relief device is adapted, upon complying with a triggering condition (e.g. on reaching and/or exceeding a temperature threshold value), to open a duct between the pressure vessel connecting element of the pressure-relief device and an outlet opening of the pressure-relief device. By opening the duct, the fluid, e.g. fuel, that is stored inside the pressure vessel, is able to flow via the duct out of the pressure vessel connected to the pressure vessel connecting element and into the vicinity of the pressure vessel, in order to reduce the internal pressure in the interior of the pressure vessel. By reducing the internal pressure of the pressure vessel, for example in the event of a fire in the vicinity of the pressure vessel, the risk of the abrupt failure of the pressure vessel is reduced. For the purpose of opening the duct, one or a plurality of closure parts of the pressure-relief device can be displaced in order to expose one or a plurality of partial ducts through the pressure-relief device.

The pressure-relief device can further be adapted to reduce the cross section of the duct as the internal pressure of the pressure vessel connected to the pressure vessel connection element falls. In particular, the relevant cross section of the duct for the mass flow of the fluid flowing through the duct can be reduced in this case in order to reduce the mass flow. The cross section of the duct can be reduced in particular if the sum of the difference in the pressure at the pressure vessel connection element and the pressure at the outlet opening falls.

The pressure-relief device can thus be adapted, at a relatively high internal pressure of the pressure vessel (i.e. at a relatively high pressure at the pressure vessel connection element), to make available an outlet duct with a relatively large cross section. On the other hand, an outflow duct with a relatively small cross section can be made available at a relatively low internal pressure of the pressure vessel. The reduction in cross section can take place continuously in steps in this case as the internal pressure of the pressure vessel falls. A relatively high mass flow of the fluid exiting from the pressure vessel can thus be achieved at a relatively high internal pressure of the pressure vessel, in order to reduce the risk of bursting of the pressure vessel as quickly as possible. On the other hand, at a relatively low internal pressure of the pressure vessel, a relatively low mass flow of the fluid exiting from the pressure vessel can be achieved in order to reduce a risk, caused by the exiting fluid, in the vicinity of the pressure vessel (e.g. a fire risk). The pressure-relief device described in this document thus enables the safety of a pressure vessel to be increased (in particular in a fire situation and/or an accident situation).

The pressure-relief device can be adapted to reduce the cross section of the duct as soon as the internal pressure reaches or falls below a pressure threshold value. The pressure threshold value in this case can be dependent on a bursting pressure of the pressure vessel. In particular, the pressure threshold value can be dependent on the bursting pressure of the pressure vessel if a specific condition of the surroundings of the pressure vessel (e.g. a specific temperature of the surroundings of the pressure vessel) is met.

The triggering condition for the pressure-relief device can involve, for example, reaching or exceeding a temperature threshold value at the pressure-relief device. In particular in the event of reaching a temperature threshold value (e.g. 110° C.), a triggering element (e.g. a glass ampoule or eutectic) of the pressure-relief device can trigger in order to expose the duct through the pressure-relief element. The pressure threshold value can then be dependent on the bursting pressure of the pressure vessel at a temperature which is the same or greater than the temperature threshold value. The safety of the pressure vessel can be further increased by taking the bursting pressure of the pressure vessel into account in the design of the pressure-relief device.

The pressure-relief device can comprise two or more different orifices, which permit two or more different cross sections of the duct. The two or more orifices can permit the passage of fuel at least partially at different internal pressures. In particular at a relatively high internal pressure, at least one orifice with a relatively large cross section can be passable. On the other hand, at a relatively low internal pressure, only one or a plurality of orifices with a relatively small cross section can be passable.

The pressure-relief device can comprise at least one orifice, which influences the cross section of the duct, wherein the geometry of the orifice (in particular the cross section caused by the orifice) is dependent on the internal pressure of the pressure vessel. For example, the orifice can comprise a flexible material which deforms to different extents depending on the difference in pressure between the pressure vessel connection element and the outlet opening and, as a result, varies the cross section of the duct. An efficient and reliable adaptation of the cross section of the duct is thus permitted by the pressure-relief device.

The pressure-relief device typically comprises a housing, on which (on a first side) the pressure vessel connection element and on which (on a different, second side) the outlet opening of the pressure-relief device are arranged. The housing can be designed to comprise the duct between the pressure vessel connection element and the outlet opening. The housing can be cylindrical, for example.

The pressure-relief device can be adapted, depending on the internal pressure, to open a main duct and/or a secondary duct of the (entire) duct to the outlet opening, in order to vary the cross section of the (entire) duct. In other words, a plurality of different secondary ducts (e.g. a main duct and a secondary duct) can be made available inside the casing of the pressure-relief device, which together constitute an (entire) duct with a specific cross section. The secondary ducts can be opened at least partially depending on the internal pressure of the pressure vessel, in order to adjust the cross section of the (entire) duct through the pressure-relief device. By the provision of different secondary ducts, which can be opened or closed selectively depending on the pressure conditions, the cross section of the (entire) duct through the pressure-relief device can be adjusted in steps in a reliable manner.

In particular, the pressure-relief device can be configured, upon complying with the triggering conditions, to open both the main duct and the secondary duct to the outlet opening when the internal pressure is greater than the pressure threshold value. The cross section of the (entire) duct then comprises the cross section of the main duct and the cross section of the secondary duct. Furthermore, the pressure-relief device can be configured to close the main duct once more while the secondary duct is opened further when the internal pressure reaches or exceeds the pressure threshold value. The cross section of the (entire) duct then comprises the cross section of the secondary duct, but no longer comprises the cross section of the main duct.

The pressure-relief device can be a main closure part enclosed by the housing (e.g. a main taper), which bears against a main seating of the housing in a closed condition of the pressure-relief device, and, in so doing, closes the main duct. The main closure part can be moved away from the main seating inside the housing in order to open the main duct, or can be moved towards the main seating in order to close the main duct.

Furthermore, the pressure-relief device can comprise a secondary closure part enclosed by the main closure part (e.g. a secondary taper), which bears against a secondary seating of the main closure part in a closed state of the pressure-relief device and, in so doing, closes the secondary duct. The secondary duct in this case runs at least partially through the main closure part. The secondary closure part can be moved away from the secondary seating inside the secondary closure part in order to open the secondary duct, or can be moved towards the main seating in order to close the secondary duct. Different secondary ducts can thus be made available in an efficient manner inside the pressure-relief device.

The pressure-relief device can comprise a spring, which is adapted to press the main closure part against the main seating. The spring can be adapted (by a corresponding restoring force) to press the main closure part back onto the main seating in order to close the main duct once more when the internal pressure reaches or falls below the pressure threshold value. The main duct can thus be closed once more, on reaching the pressure threshold value, in order to reduce the cross section of the (entire) duct.

As already explained above, the pressure-relief device can comprise a triggering element (e.g. in the form of an ampoule, which breaks if the triggering condition is met). The triggering element can be adapted to press the secondary closure part against the secondary seating (and, in so doing, to close the secondary duct and also possibly the main duct). Furthermore, the triggering element can be adapted to release the secondary closure part in order to open the secondary duct, which runs through the main closure part to the outlet opening, when the triggering condition is met. By releasing the secondary closure part, it is also possible to release the main closure part, if required, so that the main duct is also opened. For example, the triggering element situated behind the secondary closure part relative to the pressure vessel connection element can be destroyed if the triggering condition is met, so that the secondary closure part is forced away from the secondary seating by the internal pressure acting on the secondary closure part, in order to open the secondary duct. In addition, the main closure part can also be forced away from the main seating by the internal pressure acting on the main closure part, in order to open the secondary duct.

According to a further feature, a method for controlling a pressure-relief device for a pressure vessel is described. The method can be implemented, for example, with an electronic control unit of an electronically controllable pressure-relief device and, if required, with a pressure sensor for determining the vessel pressure. The pressure vessel can be designed for storing a fuel which is gaseous at ambient pressure, in particular a fuel. The method involves opening at least one duct between a pressure vessel connection element of the pressure-relief device and an outlet opening of the pressure-relief device, upon complying with a triggering condition, when a triggering condition of the pressure-relief device is met. In this case, fuel is able to flow through the created duct from the pressure vessel connection element into the vicinity of the pressure-relief device, in order to reduce the internal pressure in the interior of the pressure vessel connected to the pressure vessel connection element. The method further involves reducing a cross section of the duct when the pressure at the pressure vessel connection element falls.

According to a further feature, a pressure vessel for storing a fuel is described, wherein the pressure vessel comprises the pressure-relief device described in this document.

According to a further feature, a vehicle (in particular a motorized road vehicle, for example a passenger vehicle or a goods vehicle) is described, which comprises the pressure vessel described in this document.

It should be noted that the methods, devices and systems described in this document can be used both alone and also in combination with other methods, devices and systems described in this document. Furthermore, all features of the methods, devices and systems described in this document can be combined with one another in many different ways.

The invention is described below on the basis of illustrative embodiments. Other objects, advantages and novel features of the present invention will become apparent from the following detailed description of one or more preferred embodiments when considered in conjunction with the accompanying drawings.

### BRIEF DESCRIPTION OF THE DRAWINGS

FIG. 1A depicts an illustrative pressure vessel arrangement in a vehicle.

FIG. 1B depicts an illustrative pressure-relief device.

FIGS. 2A, 2B and 2C depict different conditions of an illustrative pressure-relief device.

FIG. 2D depicts an illustrative pressure/mass flow graph for the pressure-relief device in FIG. 2A.

FIGS. 3A, 3B depict different conditions of an illustrative pressure-relief device.

FIG. 4 depicts a flow chart of an illustrative method for adapting the mass flow by means of a pressure-relief device.

### DETAILED DESCRIPTION OF THE DRAWINGS

As stated by way of introduction, the present document is concerned with making available a pressure-relief device for a pressure vessel, by which the safety of the pressure vessel can be increased. In this case, the present document is concerned in particular with a pressure vessel for a pressure vessel system (in particular a compressed hydrogen storage system (=CHS System)) for a motorized vehicle. The pressure vessel system serves for storage of fuel or fuel that is in gaseous form under ambient conditions. The pressure vessel system can be installed, for example, in a motorized vehicle that is powered by compressed (“compressed natural gas”=CNG) or liquefied (LNG) natural gas or by hydrogen.

A pressure vessel system of this type comprises at least one pressure vessel or pressure tank. For example, the pressure vessel can be a cryogenic pressure vessel (=CcH2) or a high-pressure gas container (=CGH2).

High-pressure gas containers are configured, mainly at ambient temperatures, to store fuel permanently at a nominal operating pressure (also known as the nominal working pressure or NWP) of approx. 350 bar (overpressure above atmospheric pressure), and more preferably of approx. 700 bar or more. A cryogenic pressure vessel is adapted to store the fuel or the fuel at the aforementioned operating pressures, and at temperatures which lie significantly below the operating temperature of the motor vehicle.

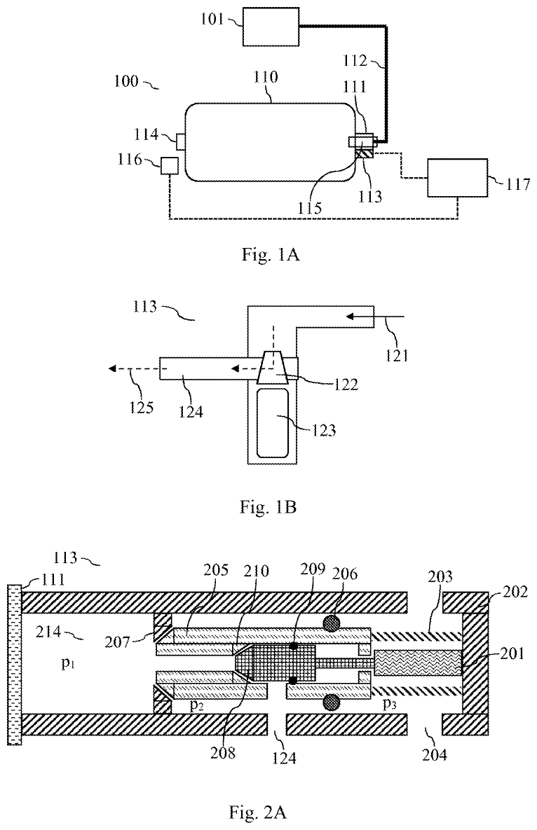

FIG. 1A depicts an illustrative pressure vessel arrangement and an illustrative pressure vessel system 100 with a pressure tank and a pressure vessel 110, which can be used to make available fuel (including hydrogen) for a fuel consumer (e.g. a fuel cell) 101 of a motor vehicle. The pressure vessel 110 is connected via a line 112 to the fuel consumer 101.

The pressure vessel 110 can exhibit end pieces 111, 114 on its end faces, which can be used in the manufacture of the pressure vessel 110 for gripping and, if required, for turning the pressure vessel 110. Furthermore, an opening can be provided on one end piece 111, through which opening fuel can be led from the pressure vessel 110 (e.g. via a valve 115 to the line 112). A pressure-relief device 113, which, if a specific triggering condition is met (e.g. if a specific temperature of about 110° C. is met), is able to be triggered in order to release fuel from the pressure vessel 110 into the vicinity of the pressure vessel 110 and, in so doing, to reduce the pressure in the pressure vessel 110, is typically arranged on an opening of the pressure vessel 110 (if required at openings on both end pieces 111, 114).

A pressure vessel 110 typically comprises at least one fiber-reinforced layer. The fiber-reinforced layer can preferably completely enclose a liner, at least in some areas. The fiber-reinforced layer is often also described as a laminate, a cladding or a reinforcement. Fiber-reinforced plastics (also abbreviated to FRP), for example carbon fiber-reinforced plastics (CFRP) and/or glass fiber-reinforced plastics (GRP), find an application as a fiber-reinforced layer. A fiber-reinforced layer expediently includes reinforcing fibers embedded in a plastic matrix.

FIG. 1B depicts an illustrative pressure-relief device 113. In a closed state, an outlet opening 124 of the pressure-relief device 113 is closed by way of a stopper or a closure part 122, wherein the stopper 122 is retained by an ampoule 123 in such a way that the outlet opening 124 remains closed. The ampoule 123 typically contains a liquid, which expands when it is heated, so that the ampoule 123 breaks when the triggering condition is met. The stopper 122 then exposes the outlet opening 124, so that fuel 125 is able to flow via the outlet opening 124 from the pressure vessel 110 (see the arrow 121). The ampoule 123 constitutes an illustrative triggering element, which is adapted to determine whether the triggering condition for the pressure-relief device 113 has been met.

The discharge of fuel 125 enables the pressure inside a pressure vessel 110 to be reduced, so that the risk of bursting of the pressure vessel 110 is reduced. On the other hand, the fuel 125 flowing out is able, if required, to ignite at a certain distance from the outlet opening 124, and, if required, to start a fire. In the process, the risk of ignition and/or the heat effect associated with a fire and/or the hazard radius due to the fuel 125 flowing out are typically increased with the mass flow of the fuel 125 flowing out. Furthermore, atmospheric oxygen can be displaced by the fuel 125 flowing out (in particular in a tunnel and/or in a garage), wherein this displacement effect increases with an increasing mass flow. On the one hand, the discharge of fuel 125 thus enables the risk of bursting of the pressure vessel 110 to be reduced. On the other hand, a relatively high mass flow of fuel 125 flowing out can constitute a risk to the immediate vicinity of the pressure vessel 110.

The failure of a pressure vessel 110, e.g. in the event of a fire, typically depends primarily on the internal pressure of the vessel. Bursting of the pressure vessel 110 occurs at higher pressures (e.g. due to failure of the CFRP reinforcement). Leakage of the pressure vessel 110 can occur at lower pressures (e.g. due to melting of the liner). The mass flow of the fuel 125 during discharge should accordingly be dependent on the pressure inside the pressure vessel 110. The mass flow should be relatively high at a higher pressure inside the pressure vessel 110, and the mass flow should be lower at a lower pressure inside the pressure vessel 110. In particular, discharging of the pressure vessel 110 should take place as quickly as possible, and the mass flow should be relatively high, for as long as the pressure inside the pressure vessel 110 could still lead to bursting of the pressure vessel 110.

If, on the other hand, the pressure inside the pressure vessel 110 is lower (where appropriate taking into account a margin of safety) than the pressure at which bursting of the pressure vessel 110 may occur, discharging should take place more slowly, and the mass flow should be lower.

In order to reduce the risk of bursting of the pressure vessel 110, the pressure inside the pressure vessel 110 should thus be reduced as quickly as possible at least to a specific pressure threshold value. This can be achieved by the highest possible mass flow of the exiting fuel 125. On the other hand, the mass flow of the exiting fuel 125 should be kept as low as possible (at least as soon as the specific pressure threshold value has been achieved or not met), in order to reduce risks to the surroundings of the pressure vessel 110.

In principle openings 124, from which a fluid flows from a higher pressure to a lower pressure, already exhibit the characteristic feature that the mass flow of the fluid is higher, the higher the pressure inside the pressure vessel 110. In this document, however, it is proposed to amplify this effect by adapting the geometry of the pressure-relief device 113 and by controlling or regulating the mass flow of the fuel 125 accordingly. Typically, it is not possible to achieve a sufficiently higher mass flow above a critical pressure threshold value and/or a sufficiently lower mass flow below the critical pressure threshold value solely on the basis of the laws of flow with a fixed geometry of a pressure-relief device 113.

The pressure-relief device 113 can have a number of different apertures, for example, by which the cross section of the outlet opening 124 and/or the cross section of a duct leading to the outlet opening 124 of the pressure-relief device 113 is defined. The different orifices can be passable, at least partially, at a different internal pressure of the vessel, and are thus able to vary the cross section of the outlet opening 124 and/or of the duct depending on the internal pressure of the vessel. The mass flow of the exiting fuel 125 can thus be varied depending on the internal pressure of the vessel. As an alternative or in addition, the geometry of one or more orifices of a pressure-relief device 113 can be varied depending on the internal pressure of the vessel, and the cross section of the outlet opening 124 and/or the duct can be varied as a result.

The pressure-relief device 113 of a pressure vessel 100 can thus be adapted to reduce the degree of opening of a duct through the pressure-relief device 113 with a falling pressure of the medium inside the pressure vessel 110. A duct with a relatively high degree of opening can thus be made available at a relatively high internal pressure of the duct, in order to reduce the internal pressure of the vessel to a specific pressure threshold value as quickly as possible by a relatively high mass flow (in order to reduce the risk of bursting of the pressure vessel 110). On the other hand, at a relatively low internal pressure of the vessel (e.g. above the pressure threshold value), the degree of opening of the duct can be reduced, in order to reduce risks to the immediate vicinity of the pressure vessel 110 by a relatively low mass flow. In particular, it is thus possible to avoid an unnecessarily large mass flow at a relatively small internal pressure of the vessel. The safety of a pressure vessel 110 (e.g. in the event of a fire) can be increased as a result.

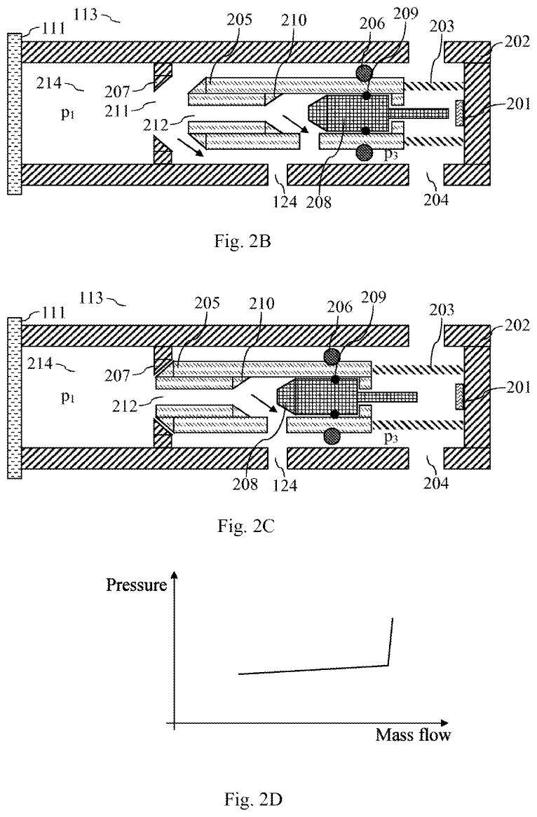

FIG. 2A depicts an illustrative pressure-relief device 113 for a pressure vessel 110. The pressure-relief device 113 in the illustrative example is connected in a fluid-tight manner via a pressure vessel connection element 214 (e.g. with a thread) to the pressure vessel 110, e.g. to an end piece 111 of the pressure vessel 110. In FIG. 2A, the internal pressure of the vessel is designated by p1, the ambient pressure (e.g. the atmospheric pressure) is designated by p3, and a back pressure at the main taper 205 of the pressure-relief device 113 is designated by p2. The pressure-relief device 113 comprises, as already illustrated in FIG. 1B, a triggering element 201, e.g. an ampoule 123, which triggers if a triggering condition is met, in particular if a specific temperature is met, and in so doing releases the main taper 205 and the secondary taper 208 of the pressure-relief device 113. As illustrated in FIG. 2B, a main duct 211 (where appropriate with a relatively large cross section) can be exposed by the main taper 205, in order to permit a relatively high mass flow. On the other hand, a secondary duct 212 (where appropriate with a relatively small cross section) can be exposed by the secondary taper 208, in order to permit a relatively low mass flow.

The main taper 205 and the secondary taper 208 are disposed in a housing 202 of the pressure-relief device 113. FIG. 2A illustrates the pressure-relief device 113 in a closed state. The main taper 205 in this case sits against a main seating 207 of the pressure-relief device 113, wherein the main seating 207 is fixedly connected to the housing 202. The main taper 205 thus closes the main duct 211. The main taper 205 is pressed against the main seating 207 by a spring 203.

The secondary seating 208 is enclosed by the main taper 205 and bears against a secondary seating 210 disposed on the main taper 205 in the closed condition, in order to close the secondary duct 212 running through the main taper 205. The secondary taper 208 is pressed against the secondary seating 210 by the triggering element 201. FIG. 2A also depicts a sealing ring 206 of the main taper 205 and a sealing ring 209 of the secondary taper 208.

The triggering element 201 triggers if the triggering condition is met. If the internal pressure p1 of the vessel is sufficiently high to overcome the restoring force of the spring 203, both the main duct 211 and the secondary duct 212 are exposed, as illustrated in FIG. 2B, so that, at a relatively high internal pressure p1 of the vessel, a relatively high mass flow of exiting fuel 125 is facilitated. The spring 203 typically does not act on the secondary taper 208, so that the secondary duct 212 is opened, even at a relatively low internal pressure p1 of the vessel (including in the event of the main duct 211 not being opened), and/or complete reclosing of the pressure-relief device 113 is prevented.

If the internal pressure p1 of the vessel falls, the restoring force of the spring 203 causes the main taper 205 to be pressed (if appropriate pressed back) against the main taper 207 and, in so doing, closes the main duct 211. On the other hand, the secondary duct 212 continues to remain open. A reduced mass flow of exiting fuel 125 is thus facilitated at a reduced internal pressure p1 of the vessel. The fuel 125 exits via the output opening 124 of the pressure-relief device 113. FIGS. 2A, 2B, 2C further depict a convection opening 204 of the pressure-relief device 113.

FIG. 2D depicts an illustrative pressure/mass flow graph for the pressure-relief device 113 represented in FIGS. 2A, 2B and 2C. It can be appreciated that, upon reaching or falling below a specific pressure threshold value, the mass flow of the exiting fuel 125 is reduced abruptly (by closing the main duct 211).

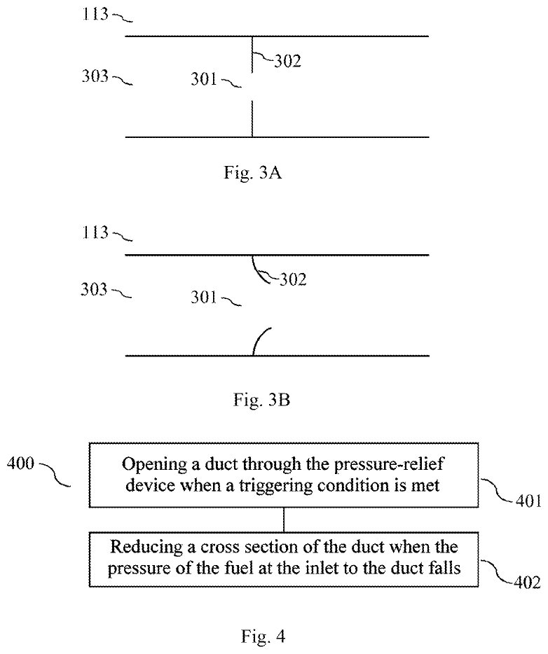

FIGS. 3A and 3B depict an illustrative pressure-relief device 113 with a flexible orifice 302. At a relatively high internal pressure of the vessel, the aperture 302 can be bent, as illustrated in FIG. 3B, so that the cross section 301 of the (entire) duct 303 through the pressure-relief device 113 is relatively large and thus permits a relatively large mass flow. On the other hand, no bending or reduced bending of the aperture 302 takes place at a relatively low internal pressure of the vessel, so that the cross section of the (entire) duct 303, and thus the mass flow, are reduced.

FIG. 4 depicts a flow chart of an illustrative process 400 for controlling a pressure-relief device 113 for a pressure vessel 110, wherein the pressure vessel 110 serves, for example, for storing a fuel 125 that is gaseous at ambient pressure. The method 400 can be implemented by a control unit 117 of the pressure-relief device 113 (e.g. in an electronically controlled pressure-relief device 113). This is illustrated by way of example in FIG. 1A. In particular, FIG. 1A depicts an optional control unit 117 and an optional pressure sensor 116. The pressure sensor 116 can be adapted to collect sensor data in respect of the internal pressure of the vessel of the pressure vessel 110. The control unit 117 can be adapted to control one or more actuators of the pressure-relief device 113, depending on the sensor data, in order to carry out the method.

On the other hand, the method 400 can be implemented by a corresponding mechanical design of the pressure-relief device 113.

The method 400 involves opening 401 a duct 303 between a pressure vessel connection element 214 of the pressure-relief device 113 and an outlet opening 124 of the pressure-relief device 113, when a triggering condition of the pressure-relief device 113 is met. By opening 401 the duct 303, fuel 125 is allowed to flow through the duct 303 from a pressure vessel 110 connected to the pressure vessel connection element 214 through the outlet opening 124 into the vicinity of the pressure-relief device 113, in order to reduce the internal pressure in the interior of the pressure vessel 110.

In addition, the method 400 involves reducing 402 a cross section 301 of the duct 303 when the pressure at the pressure vessel connection element 214 falls. The mass flow of the fuel 125 flowing through pressure-relief device 113 can be reduced by reducing the cross section 301 of the duct 303.

The present invention is not restricted to the depicted illustrative embodiments. It should be noted in particular that the description and the figures are intended to illustrate only the principle of the proposed methods, devices and systems.

### LIST OF REFERENCE DESIGNATIONS

100 pressure vessel system
101 fuel consumer
110 pressure vessel
111, 114 end piece
112 line
113 pressure-relief device
115 valve
116 pressure sensor
117 control unit
121 direction of flow
122 closure part (stopper)
123 ampoule
124 outlet opening
125 fuel
201 triggering element
202 housing
203 spring
204 convection opening
205 main closure part (main taper)
206 seal of the main closure part
207 main seating
208 secondary closure part (secondary taper)
209 seal of the secondary closure part
210 secondary seating
211 main duct
212 secondary duct
214 pressure vessel connection element
301 cross section
302 orifice
303 duct
400 method for controlling a pressure-relief device
401-402 method steps

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A pressure-relief device for a pressure vessel for storing a fuel which is gaseous at ambient pressure, comprising:
a duct which, upon complying with a triggering condition, opens between a pressure vessel connection element of the pressure-relief device and an outlet opening of the pressure-relief device, whereby fuel is able to flow via the duct out of the pressure vessel connected to the pressure vessel connection element and into a vicinity of the pressure vessel in order to reduce an internal pressure in the interior of the pressure vessel, and
wherein, with reducing internal pressure in the pressure vessel connected to the pressure vessel connection element, a cross-section of the duct is reduced.

2. The pressure-relief device according to claim 1, wherein
the pressure-relief device is adapted to reduce the cross section of the duct as soon as the internal pressure reaches or falls below a pressure threshold value, and
the pressure threshold value is dependent on a bursting pressure of the pressure vessel.

3. The pressure-relief device according to claim 2, wherein
the triggering condition involves reaching and/or exceeding a temperature threshold value at the pressure-relief device, and
the pressure threshold value is dependent on the bursting pressure of the pressure vessel at a temperature which is the same as or greater than the temperature threshold value.

4. The pressure-relief device according to claim 1, wherein
the pressure-relief device comprises two or more orifices, which permit two or more different cross sections of the duct, and
the two or more orifices permit passage of fuel at least partially at different internal pressures.

5. The pressure-relief device according to claim 1, wherein
the pressure-relief device comprises at least one orifice, which influences the cross section of the duct, and
a geometry of the orifice is dependent on the internal pressure of the pressure vessel.

6. The pressure-relief device according to claim 1, wherein
the pressure-relief device comprises a housing, on which the pressure vessel connection element and the outlet opening of the pressure-relief device are arranged, and which is configured to constitute the duct between the pressure-vessel connection element and the outlet opening, and
the pressure-relief device is adapted, depending on the internal pressure, to open a main duct and/or a secondary duct of the duct to the outlet opening, in order to vary the cross section of the duct.

7. The pressure-relief device according to claim 6, further comprising:
a main closure part enclosed by the housing, which bears against a main seating of the housing in a closed condition of the pressure-relief device and, in so doing, closes the main duct, and
a secondary closure part enclosed by the main closure part, which bears against a secondary seating of the main closure part in a closed condition of the pressure-relief device and, in so doing, closes the secondary duct, wherein
the secondary duct runs at least partially through the main closure part.

8. The pressure-relief device according to claim 7, wherein
the pressure-relief device comprises a spring, which is adapted to press the main closure part against the main seating, and
the spring is configured to press the main closure part back onto the main seating in order to close the main duct once more when the internal pressure reaches or falls below a pressure threshold value.

9. The pressure-relief device according to claim 8, wherein
the pressure-relief device comprises a triggering element,
the triggering element is adapted to press the secondary closure part against the secondary seating, and
the triggering element is adapted to release the secondary closure part in order to open the secondary duct through the main closure part to the outlet opening when the triggering condition is met.

10. The pressure-relief device according to claim 7, wherein
the pressure-relief device comprises a triggering element,
the triggering element is adapted to press the secondary closure part against the secondary seating, and
the triggering element is adapted to release the secondary closure part in order to open the secondary duct through the main closure part to the outlet opening when the triggering condition is met.

11. The pressure-relief device according to claim 6, wherein the pressure-relief device is configured to:
upon complying with the triggering condition, open the main duct and the secondary duct to the outlet opening, when the internal pressure is greater than a pressure threshold value, and
close the main duct once more while the secondary duct continues to remain open, when the internal pressure reaches or exceeds the pressure threshold value.

12. A method for controlling a pressure-relief device for a pressure vessel for storing a fuel which is gaseous at ambient pressure, the method comprising:
opening a duct between a pressure vessel connection element of the pressure-relief device and an outlet opening of the pressure-relief device, when a triggering condition of the pressure-relief device is met, wherein fuel is able to flow through the duct from the pressure vessel connection element into a vicinity of the pressure-relief device, in order to reduce an internal pressure in an interior of the pressure vessel connected to the pressure vessel connection element, and
reducing a cross section of the duct when the pressure at the pressure vessel connection element falls.
